(19) United States
(12) Patent Application Publication
(10) Pub. No.: US 2019/0129836 A1
(43) Pub. Date: May 2, 2019

(54) COMPUTER PROCESSING UNIT (CPU) ARCHITECTURE FOR CONTROLLED AND LOW POWER SAVE OF CPU DATA TO PERSISTENT MEMORY

(71) Applicant: Futurewei Technologies, Inc., Plano, TX (US)

(72) Inventor: Thomas BOYLE, Santa Clara, CA (US)

(21) Appl. No.: 15/795,530

(22) Filed: Oct. 27, 2017

(51) Int. Cl. G06F 12/02; G06F 1/32; G06F 12/0831; G06F 12/128; G06F 15/78

(52) U.S. Cl. CPC G06F 12/0246; G06F 1/3275; G06F 1/3243; G06F 1/3287; G06F 12/0855; G06F 12/128; G06F 15/781; G06F 2212/621; G06F 12/0831

(57) ABSTRACT

Improvements to computer processing unit (CPU) architecture flush caches to persistent memory (PM) memory devices (e.g., persistent memory in dual in-line memory modules or PM DIMMs) after system power failure and perform specific shutdown of system on chip (SOC) and CPU components to lower auxiliary power cost and obviate CPU processing delays associated with cache flushes to PM memories at synchronization points. CPU architecture improvements comprise separating power lines used by a SOC into parts that can be immediately shutoff upon power failure and parts that receive auxiliary power, and using a power shutdown controller upon system power failure to control terminating auxiliary power to CPU components (e.g., L1, L2 and L3 caches) upon completion of cache flush at each level of CPU memory hierarchy to decrease power consumption by higher powered components as quickly as possible until all data is safely saved on PM memories.

### TECHNICAL FIELD

The present invention relates generally to a central processing unit (CPU) and, in particular embodiments, to CPU enhancements for improving safety of CPU data after a power failure.

### BACKGROUND

A persistent dual in-line memory module (DIMM) technology has recently emerged which has the property that its contents will be stored or saved after power failure. For example, Micron Technology Inc. has developed 3D-xpoint dual in-line memory modules (DIMMs). Further, in addition to non-volatile dual in-line memory modules (NVDIMMs) (i.e., memory with save to flash feature), various manufacturers now provide NVIDIMM-P which has persistent memory (PM) and is a combination of memory cache, dense flash and new protocols. Some of these persistent memory DIMMs have dramatically greater capacity than ordinary DIMMs, allowing for faster in-memory processing with greater amounts of data that can be safe after a power failure.

A proposed use for these persistent memory DIMMs is to perform high speed processing on CPU cores on the cached part and then, at synchronization points, to flush the caches to this type of persistent memory DIMMs (PM DIMMs). These synchronization points can be frequent, and the delays at these synchronization points decrease system performance because the time to wait for data to flush from cache to persistent memory can be long when compared to optimal speed attainable when running in a CPU pipeline accessing data from only in the cache.

### SUMMARY

Embodiments of the disclosure allow efficient use of auxiliary power to a CPU when system power failure occurs by providing separate power lines to CPU components that flush CPU cache data to persistent memory (PM) memory devices (e.g., PM DIMMs or similar PM memory devices that are soldered to the board rather than deployed in slots), and controlled shutdown of auxiliary power to these CPU components upon power failure. By allowing for cache flush to these PM memories to be deferred until power failure, embodiments also obviate the need for synchronization points with cache flushes to persistent memory, thereby permitting the CPU to run at higher speeds.

In accordance with aspects of illustrative embodiments, a system on chip (SOC) having a computer processing unit (CPU) connected to PM memories comprises a power shutdown controller comprising a power input configured to receive power from a system power source and from an auxiliary power source upon a system power failure, and a plurality of power output lines that are connected, respectively, to designated CPU components comprising plural CPU cores, plural levels of cache and a memory physical interface to the PM memories to provide power from the power input. The power shutdown controller is configured to receive signals from at least one of the CPU components indicating when cache emptying of CPU data from the CPU components is completed after system power failure. In response to the indication of cache emptying completion to the PM memories, the power shutdown controller generates an output signal to request terminating power to the power input from the auxiliary power source.

In accordance with aspects of illustrative embodiments, the plurality of power lines comprises at least one power line that is separately controllable from the other power lines by the power shutdown controller to supply auxiliary power to and terminate auxiliary power from one or more of the CPU components that are connected to the controllable power line. For example, two or more of the plurality of power lines can be separately controllable with respect to each other and to the other power lines by the power shutdown controller to supply auxiliary power to and terminate auxiliary power from the CPU components that are connected to the controllable power lines. The power shutdown controller is configured to terminate auxiliary power to a corresponding one of the controllable power lines based on the received signals indicating cache emptying completion of the CPU components that are connected to that controllable power line.

In accordance with aspects of illustrative embodiments, the CPU components are selected from the group consisting of one or more CPU cores, CPU core first in first out (FIFO) memories, Level 1 (L1) cache, Level 2 (L2) cache, Level 3 (L3) cache, a coherent network, and double data rate (DDR) memory physical interfaces.

In accordance with aspects of illustrative embodiments, the controllable power lines are connected to the CPU core FIFO memory and L1 cache of each of the CPU cores, and the power shutdown controller is configured to terminate auxiliary power to the CPU core FIFO memory and the L1 cache via corresponding ones of the controllable power lines in response to the received signals indicating cache emptying completion of the CPU core FIFO memory and L1 cache of the respective CPU cores into the L2 cache.

In accordance with aspects of illustrative embodiments, at least one of the controllable power lines is connected to the L2 cache, and the power shutdown controller is configured to terminate auxiliary power to the L2 cache via the controllable power line in response to the received signals indicating completion of emptying the data from the L2 cache to the L3 cache.

In accordance with aspects of illustrative embodiments, at least one of the controllable power lines is connected to the L3 cache, and the power shutdown controller is configured to terminate auxiliary power to the L3 cache via the controllable power line in response to the received signals indicating completion of emptying the data from the L3 cache to the DDR physical interface (e.g., via the cache coherent interface).

In accordance with aspects of illustrative embodiments, the controllable power lines are connected to an interface of the coherent network and to the DDR physical interface, and the power shutdown controller is configured to terminate their auxiliary power to the DDR physical interface and the coherent network interface via corresponding ones of the controllable power lines in response to the received signals indicating completion of emptying the data from the DDR physical interface to the PM memories.

In accordance with another illustrative embodiment, a SOC having a CPU connected to PM memories comprises a power connection circuit having a power input configured to receive power from a system power source and from an auxiliary power source upon a system power failure, and a plurality of power output lines that are connected, respectively, to designated CPU components comprising plural CPU cores, plural levels of cache and a memory physical interface to the PM memories to provide power from the power input. A memory storage stores power shutdown control logic computer instructions executed by at least one of the CPU cores. The CPU cores are configured to determine when cache emptying of CPU data to PM memories from the CPU components is completed after system power failure, and have a port connected to an external circuit controlling the auxiliary power source. At least one of the CPU cores executes the power shutdown control logic computer instructions to generate an output signal via the port to request terminating auxiliary power to the power input in response to a determination that the cache emptying to PM memories is completed.

In accordance with aspects of illustrative embodiments, the plurality of power output lines are connected to the CPU components selected from the group consisting of a logic unit of one or more CPU cores, CPU core first in first out (FIFO) memories, Level 1 (L1) cache, Level 2 (L2) cache, Level 3 (L3) cache, a coherent network, and double data rate (DDR) memory physical interfaces.

In accordance with aspects of illustrative embodiments, each of the CPU cores can be configured to enter a low power mode in response to an indication that cache emptying is complete at that CPU core. At least one of the CPU cores is a controlling core that executes the power shutdown control logic computer instructions to generate the output signal in response to a determination that the other CPU cores and the controlling core have completed cache emptying of the CPU data to PM memories.

Additional and/or other aspects and advantages of the present invention will be set forth in the description that follows, or will be apparent from the description, or may be learned by practice of the invention. The present invention may comprise enhancements to CPU architecture having one or more of the above aspects, and/or one or more of the features and combinations thereof. The present invention may comprise one or more of the features and/or combinations of the above aspects as recited, for example, in the attached claims.

### BRIEF DESCRIPTION OF THE DRAWINGS

The above and or other aspects and advantages of embodiments of the invention will be more readily appreciated from the following detailed description, taken in conjunction with the accompanying drawings, of which:

FIG. 1 is a block diagram of at least a partial CPU architecture constructed in accordance with an embodiment of the present invention.

FIG. 2 is a flow chart illustrating power shutdown operations in the CPU architecture of FIG. 1 in accordance with an embodiment of the present invention.

FIG. 3 is a block diagram of at least a partial CPU architecture constructed in accordance with another embodiment of the present invention.

FIG. 4 is a flow chart illustrating power shutdown operations in the CPU architecture of FIG. 3 in accordance with an embodiment of the present invention.

FIG. 5 is a block diagram of at least a partial CPU architecture constructed in accordance with another embodiment of the present invention.

FIG. 6 is a flow chart illustrating power shutdown operations in the CPU architecture of FIG. 5 in accordance with an embodiment of the present invention.

Throughout the drawing figures, like reference numbers will be understood to refer to like elements, features and structures.

### DETAILED DESCRIPTION OF ILLUSTRATIVE EMBODIMENTS

In accordance with aspects of illustrative embodiments of the present invention, computer architecture enhancements are provided to a computer processing unit (CPU) to ensure data from CPU caches is saved to persistent memory at the time of a power failure by a memory save function to a specialized dynamic random access memory (DRAM) such as new persistent dual in-line memory module (DIMM) technology (PM DIMMs) or similar PM memory devices that are soldered to the CPU board rather than deployed in slots. The CPU architecture enhancements control application of external power (e.g. from battery or capacitor or other auxiliary power source) to CPU components and optionally to non-CPU components on a system on chip (SOC) so that CPU data becomes secure upon power failure and auxiliary power is saved.

The CPU architecture enhancements lower power consumption for the persistent memory save function to PM DIMMs (e.g., lower the battery or other auxiliary power cost of a CPU shutdown due to power failure) by separating power lines used by the SOC into power lines that are immediately shutoff upon power failure (e.g., power lines to non-CPU SOC components), and power lines to CPU components subject to controlled shutdown. Termination of auxiliary power supplied by the separated power lines is controlled depending on status of a CPU cache emptying process whereby CPU data empties from all caches to persistent memory on a double data rate (OUR) type of memory (e.g., PM DIMMs).

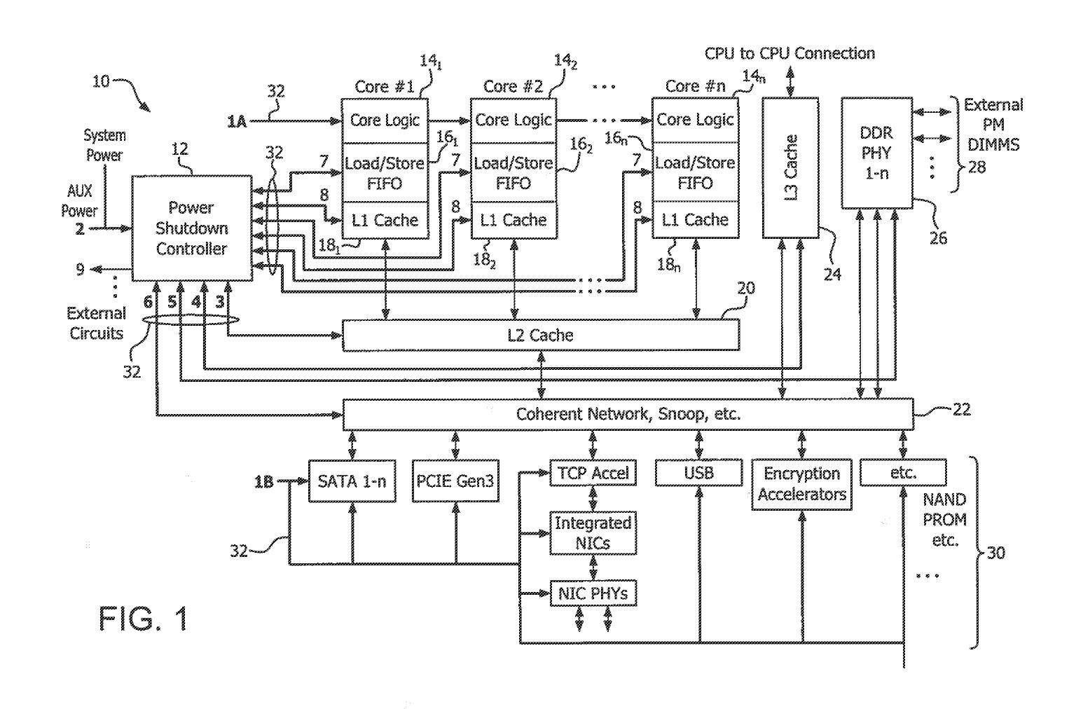

In accordance with an illustrative embodiment described below, the CPU architecture enhancements employ a specialized power shutdown controller (e.g., power shutdown controller 12 in FIG. 1) to control supply of auxiliary power to CPU components for the emptying of caches L1, L2 and L3 caches) in the CPU through to DDR (e.g., PM DIMMs) upon power failure. As described in an example below, the power shutdown controller can be configured to disable high power components such as L1, L2 and L3 caches in a hierarchical manner at respective memory steps on the SOC until all data is safely saved on special PM DIMMs or similar PM memories, thereby disabling use of high power components as quickly as possible after power failure yet ensuring that the CPU data is safely saved.

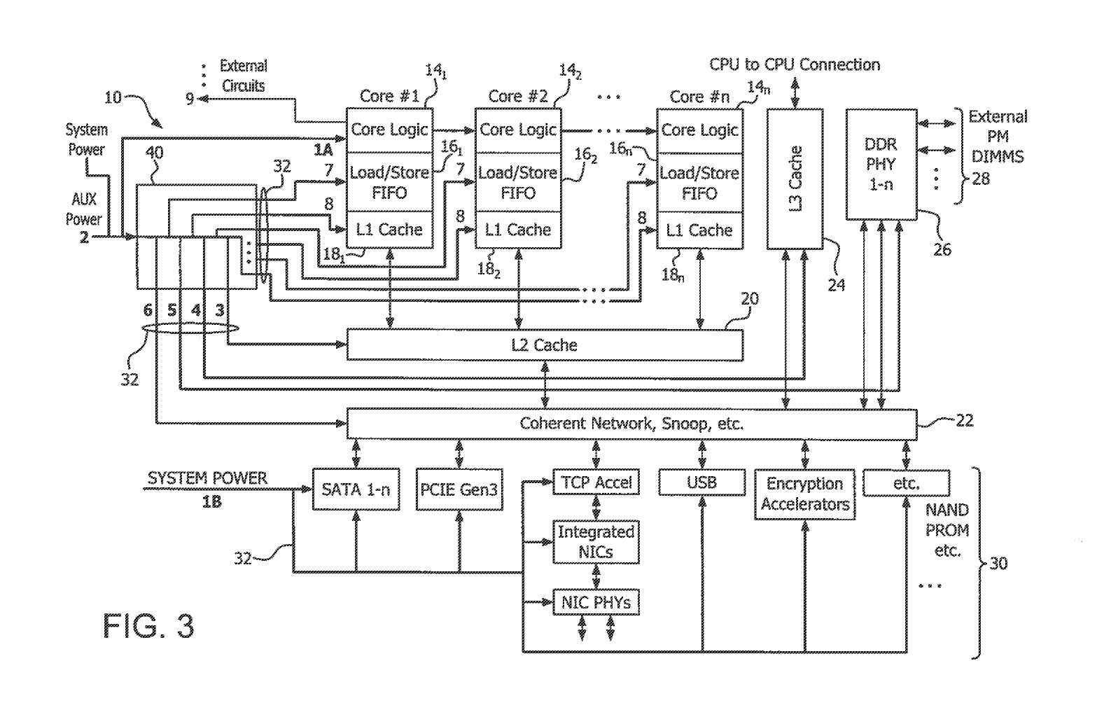

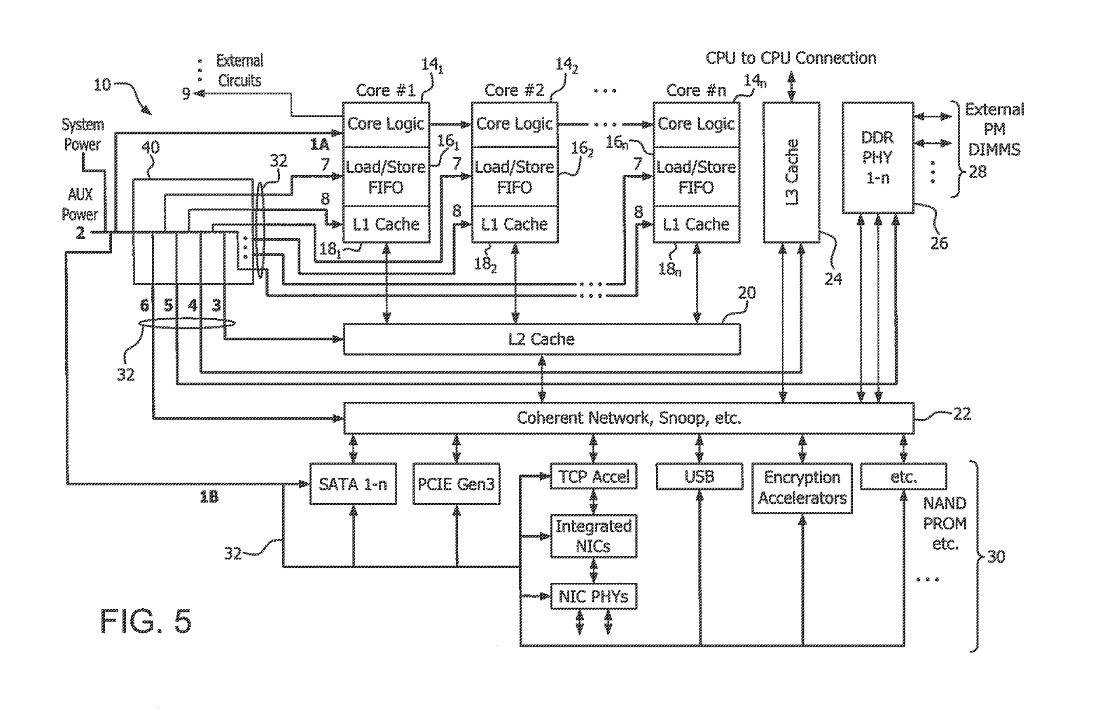

In accordance with other illustrative embodiments described below (e.g., FIGS. 3 and 5), more limited power shutdown control can be implemented in software on CPU cores to provide a simpler specialized power shutdown of essential memory emptying components used for emptying of caches (e.g., L1, L2 and L3 caches) in the CPU through to DDR (i.e., PM DIMMs). Separated power lines are provided to CPU components (FIG. 3) and, optionally, also to non-CPU components (FIG. 5) on the SOC from a power connection circuit 40, to receive system power and auxiliary power upon power failure. The CPU cores execute power shutdown control logic whereby termination of the auxiliary power to the separated power lines is requested once cache flush to PM DIMMs is complete.

Another benefit of the CPU architecture enhancements providing controlled auxiliary power shutdown that supports CPU cache emptying procedure after power failure is that synchronization points are allowed to run at highest possible speeds without requiring cache flush. In other words, cache flush can be deferred until power failure. As stated above, the time to wait for data to flush from cache to PM DIMMs can be long when compared to optimal speed attainable when running in a CPU pipeline accessing data from only in the cache. System performance is therefore improved by the CPU architecture enhancements because the time to wait for data to flush from cache to PM DIMMs at a synchronization point is obviated.

### Glossary

The following terms and definitions are provided to facilitate understanding.

CPU: computer processing unit. A CPU can contain instruction processing cores (called a CPU core) in a pipeline designed to load and store to caches and write to physical memory. Each CPU core has pipelines and typically a L1 cache of some capacity. All cores are linked to a coherent network of other caches such as L2 and L3 and connect to DDR through physical interfaces. The power consumption of cores and L1 caches, L2/L3 and DDR physical interfaces are different and under the right circumstances can be shutdown separately

coherent network: See above definition of CPU. A coherent network is a joining point for L2 caches, the L3 cache, PCIE, and finally emptying to the DDR physical interface and to the DDR.

DDR memory: double data rate (e.g., for data transfer on computer bus) type of memory.

DDR2 memory: a later form of DDR memory.

DDR3 and DDR4 memories: later forms of DDR2 memories.

DRAM: random access memory in the form of chips.

SDRAM: synchronous DRAM that is used in DDR, DDR2, DDR3,4,5, etc. RAM chips.

Non volatile memory (WM): a form of memory that when written to has the memory effectively permanently stored and readable. The write time for NVM is slow, so cannot practically be used on its own as persistent DIMM memory.

DIMM memory: dual in-line memory module. A form of DDR memories that is placed in a slot for direct use by CPUs.

Persistent DIMM memory: a form of DIMM memory that has the property that the memory content is saved when stored. There are various forms of these persistent DIMM memories described below, and these do not preclude other forms of future developed DIMM memories that have the feature that the data is also saved upon power failure.

Persistent Memory (PM memories): a memory circuit system soldered onto the board that equivalently acts as the persistent memory DIMMs in the computer system except that it is not limited to slots that it has to be plugged into.

NVDIMM-N: a type of persistent DIMM memory that self stores its memory content to NVM during a final sequence of operations initiated by system power failure. Auxiliary power supplied by a battery or capacitor provides the power for the save operation.

NVDIMM-P: a type of persistent DIMM memory that manages both NVM and regular SDRAM dynamically and saves any volatile DRAM to NVM during the loss of system power similarly to NVDIMM-N.

3D XPOINT RAM: a form of RAM invented by Intel Corporation and Micron Technology Inc. that operates at a speed similar to DRAM but the content is persistent.

PHY: a physical logic interface. A DDR PRY controls the signaling protocol from memory system to DIMM.

power failure: electrical power is removed (e.g., from an unexpected power loss, or system crash)

SATA: Serial Advanced Technology Attachment or Serial ATA. The standard hardware interface for connecting hard drives, solid state drives (SSDs) and CD/DVD drives to the computer.

Stable storage: to provide persistence, a storage medium that retains data after power is disconnected

SOC: System on a chip. System on a chip is more than just a CPU complex. It contains one or more Ethernet hardware, Ethernet physical interfaces, SATA interfaces, peripheral component interconnect express (PM) switch(es), PCIS devices, or other processing elements all on the same chip where the CPU is on the silicon. The CPU and non-CPU components consume power and under the right circumstances can be shutdown separately.

Synchronization points: a place where code has to execute in a certain order and, for aspects of illustrative embodiments described herein, may have to ensure that data is known to be persistently stored for a recovery or restart operation that would be needed after a crash or power failure.

### Example Embodiments

FIG. 1 shows some components in a CPU implemented on a SOC, by way of an example. The CPU and the SOC can have other or different components. In accordance with an illustrative embodiment, the SOC 10 comprises separated power connections indicated generally at 32 and labeled 1, 3, 4, 5, 6, 7 and 5, and power shutdown controller 12. It is to be understood that there are various ways to design a CPU and SOC. As will be described below, aspects of embodiments of the present invention operate advantageously with one or more components of a CPU (e.g., CPU cores 14₁ through 14ₙ and one or more levels of cache memory and DDR physical interfaces) to ensure data operated upon in cache memory of the CPU is moved to secure storage on special persistent memory DIMMs (PM DIMMs), or similar PM memory devices that are soldered to the CPU hoard rather than deployed in slots, in the event of a power failure, and to reduce auxiliary power needed to do so.

As shown in FIG. 1, example memory parts of the CPU core are:

1. Store buffer FIFOs 16₁ through 16ₙ on multiple CPU cores 14₁ through 14ₙ (i.e., CPU cores 14₁ through 14ₙ contain processing logic and pipeline logic that empty data into the store buffers part of the store buffer FIFO unit 16₁ through 16ₙ);

2. L1 cache memory 18₁ through 18ₙ connected to the multiple cores 14₁ through 14ₙ;

3. L2 cache memory 20 and L3 cache memory 24;

4. Coherent network 22 for PCIE, DDR or other items on the bottom of the CPU memory hierarchy; and

5. DDR physical interfaces 26 connected to external persistent memory DIMMs 28.

The path for data being processed at high speed by the CPU core pipeline flows from top to bottom in the above hierarchy listed as 1 through 5 and CPUs are designed to monitor the CPU data flow path through these CPU memory components and their statuses of cache emptying. Each CPU component consumes power. To save auxiliary power after power failure, the supply of auxiliary power to the power lines 32 (e.g. 3, 4, 5, 6, 7 and 8), and therefore to the associated CPU components receiving power from these lines 32, can be controlled (e.g., selectively shutdown once data emptying is complete) by the power shutdown controller 12 depending on the status of cache flushes of the CPU components in the above hierarchy listed as 1 through 5.

For example, the power shutdown controller 12 in FIG. 1 is configured with a power input to receive system power and, upon power failure, auxiliary power as indicated by line 2, and to controllably deliver that power via the lines 3, 4, 5, 6, 7 and 8. The power shutdown controller 12 can be a circuit comprising discrete logic components or other hardware connected to the power lines 32 (e.g., 3, 4, 5, 6, 7 and 8) and configured to disable them from delivering power to the CPU components connected to these lines. The lines 3, 4, 5, 6, 7 and 8 in FIG. 1 are drawn with arrows to their respective CPU components to illustrate power delivery. For illustrative purposes, the lines 3, 4, 5, 6, 7 and 8 in FIG. 1 are also drawn with bi-directional arrows directed into the power shutdown controller 12 to represent cache emptying status indicators provided from the different CPU components. It is to be understood that the bi-directional lines 3, 4, 5, 6, 7 and 8 do not represent power necessarily delivered on the same conductor or path as the cache emptying status indicators but rather separate traces can be used between the power shutdown controller 12 and the CPU components connected to the lines 3, 4, 5, 6, 7 and 8.

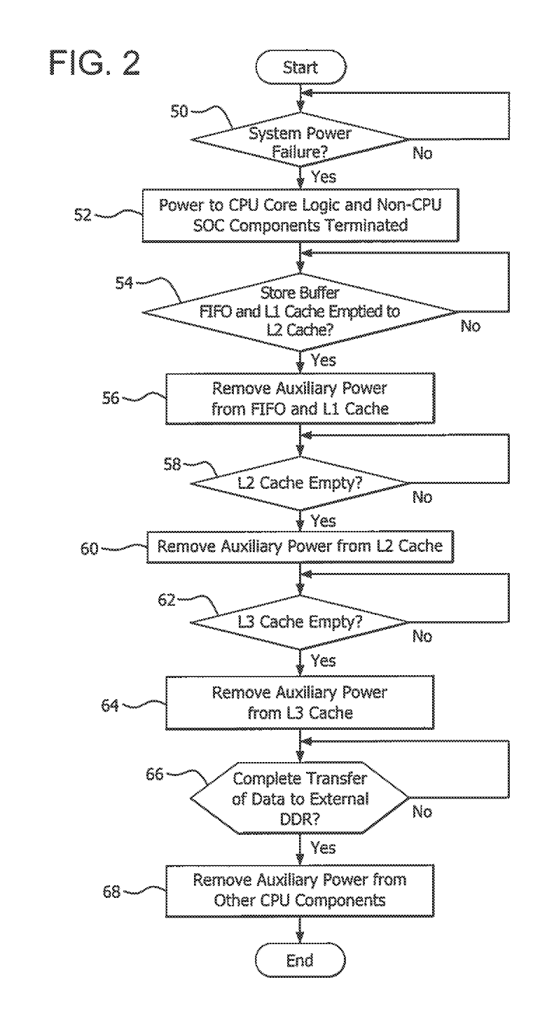

With continued reference to FIG. 1, CPU components connected to the separated power lines 32 (e.g., 3, 4, 5, 6, 7 and 8) can be shut down (e.g., one by one, as subgroups) by the power shutdown controller 12 as the data flows through the hierarchy of memory components enumerated above as 1 through 5 and then to PM DIMMs capable of saving the data after power failure based on signals received from the CPU components indicating status of cache emptying. Illustrative operations of the power shutdown controller 12 for controlled shutting down of selected ones of the CPU components are depicted in FIG. 2 and described below.

With reference to FIG. 1, the power shutdown controller 12 receives power via line 2 from a system power source and, upon power failure, from an auxiliary power source such as a battery or capacitor. An external circuit (not shown) controls the auxiliary power source supplying power to and terminating power from the power shutdown controller 12 via line 2. Line 9 indicates communication of the power shutdown controller 12 to external CPU motherboard circuits that can control power to PM DIMMs 28 and receive a control input or request to shut off power to line 2 and deactivate the CPU itself. When the power shutdown controller 12 receives one or more indications from the CPU components indicating completion of DDR flush to external DDR (e.g., PM DIMMs 28), the power shutdown controller 12 can send a signal via output 9 to the external circuit operating the auxiliary power which, in turn, terminates auxiliary power to line 2 of the power shutdown controller 12. When the power shutdown controller 12 is powered down at line 2, power is also shut down to those CPU components connected to the power lines 32 that had received auxiliary power after system power failure. As stated above, the power shutdown controller 12 in FIG. 1 can be implemented as discrete logic components or a combination of hardware and software components to selectively shut down auxiliary power received via line 2 and delivered from one or more of the power lines 32 (e.g., 3, 4, 5, 6, 7, 8).

With reference to FIG. 2, when system power failure occurs, the power shutdown controller 12 remains on due to power from an auxiliary source indicated at line 2. At time of system power failure (block 50), power to lines 1A and 1B in FIG. 1 ceases, as indicated at block 52 in FIG. 2. Line 1A shuts down power to arithmetic logic and pipeline logic on each CPU core 14. It is to be understood that the CPU is configured such that stores that were destined to the STORE FIFO 16 in each core 14 continue feeding items to the L1/L2/L3 cache system (e.g., 18, 20 and 24) without failure because their power is still provided via line 2 powering the power shutdown controller 12. Power to line 1B ceases at power failure and shuts down power to non-CPU SOC components 30 such as SATA, PCIE, NICs, USB, and so on. Auxiliary power is therefore saved by not using it for powering CPU core logic and non-CPU SOC components 30.

As illustrated at blocks 54 and 56 in FIG. 2, when the power shutdown controller 12 receives signals indicating that emptying of STORE FIFO 16 and L1 cache 18 into L2 cache 20 is complete (e.g., bi-directional lines 7,8 in FIG. 1 represent both receipt of cache emptying status information from and supply of power from the power shutdown controller 12), the power shutdown controller 12 can shut down STORE FIFO 16 and/or L1 core 20 power via respective lines 7 and 8, thereby saving power as each core 14 empties those stages. The power shutdown controller 12 can be configured to turn off STORE FIFOs 16 and L1 cache 18 of respective cores 14₁ through 14ₙ at the same time, or selectively as respective STORE FIFOs 16₁ through 16ₙ and L1 caches 18₁ through 18ₙ as each CPU core empties these stages. Since there can be many CPU cores 14 on a CPU (e.g., up to 32 or more), optimum power savings can be achieved by shutting off power on each core store FIFO 16 and L1 cache 18 as its store buffer FIFO and L1 cache empty to the common L3 cache system.

As illustrated at blocks 58, 60, 62 and 64 in FIG. 2, as the L2 cache 20 empties in to the L3 cache 24, and the L3 cache 24 empties data into the DDR physical interface 26, the power shutdown controller 12 can shut down power, respectively, to line 3 (i.e., to power down the L2 cache 20) and line 4 (i.e., to power down the L3 cache 24). The power shutdown controller 12 receives respective signals indicating that emptying L2 cache 20 into L3 cache 24 is complete, and emptying L3 cache 24 into the DDR physical interface 26 is complete, and controls shutdown of those lines 3,4.

As illustrated at blocks 66 and 68 in FIG. 2, when the power shutdown controller 12 receives an indication (e.g., represented by the bidirectional arrow on line 5) that the DDR physical interface (i.e., DDR PHY 26) has transmitted its data to external PM DIMMs 28, then the power shutdown controller 12 can control shutdown of lines 5,6 and can be used to shut everything on the CPU off if desired (e.g., by sending a signal via line 9 to the external circuit to request removal of auxiliary power from line 2). At this stage, the special persistent DDR memories 28 can employ various ways to complete their save of data to persistent memory, which is either self-controlled, BIOS-controlled or controlled by motherboard logic before the DDR memory power is turned off and data save is complete.

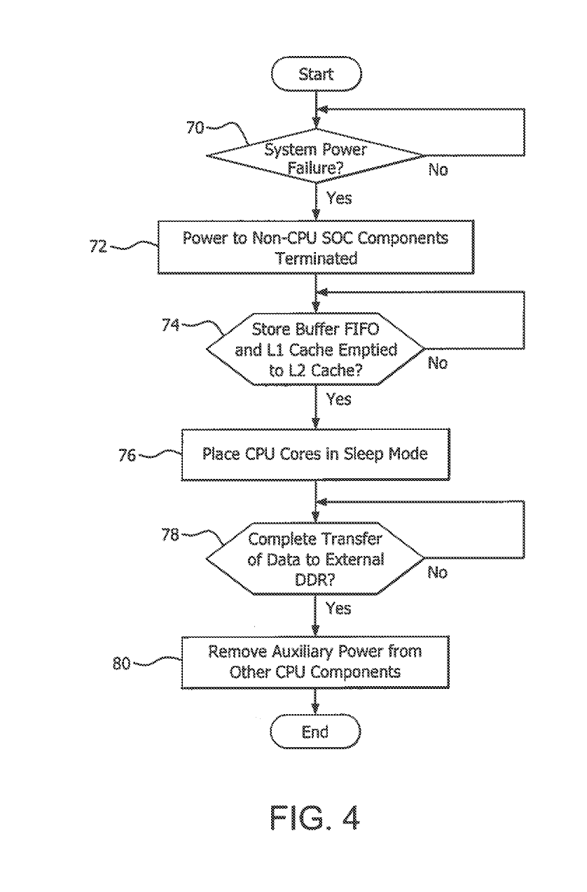

With reference to another example embodiment illustrated in FIGS. 3 and 4, some embodiments can have more limited power shutdown control than that illustrated via the example embodiment depicted using FIGS. 1 and 2. For example, lines 2 and 1A can be connected to an auxiliary power source such as a battery via the power input of the power connection circuit 40 and continue to receive auxiliary power after system power failure, and line 1B can remain connected to system power such that power to line 1B is lost upon system power failure. As illustrated in FIG. 3, the power connection circuit 40 can be a circuit wherein the power lines 3, 4, 5, 6, 7 and 8 are tied together to the power input receiving system power or auxiliary power. Related power shutdown logic is provided as software instructions executed by, for example, the cores 14₁, . . . , 14ₙ to request termination of supply of power to line 2 and therefore powering down of all CPU components receiving power via the lines 3, 4, 5, 6, 7 and 8. With reference to FIGS. 3 and 4, system power failure (block 70) only terminates power to line 18 that powers non-CPU SOC components 30 (block 72). As illustrated, power lines 3, 4, 5, 6, 7 and 8 in FIG. 3 remain on when auxiliary power is provided via line 2. In this embodiment, each core 14 can run CPU instructions that flush cache, and then wait for flush completion before placing itself into low power or sleep mode (e.g., using existing CPU software features) as indicated by blocks 74 and 76. One core (e.g., core 14₁) can operate as a controlling core because, after it empties its STORE FIFO and L1 cache, it monitors and confirms the emptying of L2, L3, DDR PHY and the final off-SOC completion of writes to PM DDR DIMMs 28 and, as indicated generally at line 9 in FIG. 3, generates a request to terminate supply of auxiliary power to line 2 (blocks 78 and 80).

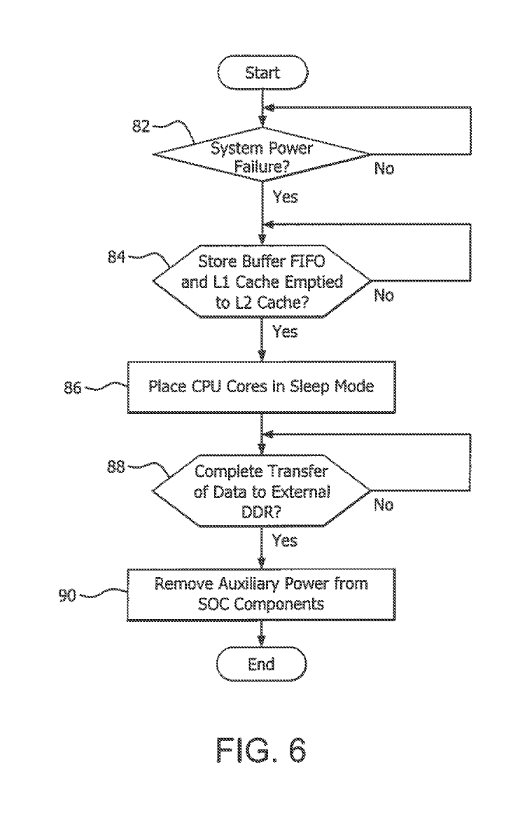

By way of another example, the illustrative embodiment in FIGS. 5 and 6 can have more limited power shutdown control than that illustrated via the example embodiment depicted using FIGS. 3 and 4. For example, the SOC 10 in FIG. 5 operates identically to that of FIG. 3 except that there is no independent system power for line 1B (i.e., line 113 is connected to the power input of the power connection circuit 40), and so line 1B remains powered by the auxiliary power source until the auxiliary power is terminated (by terminating power at line 2 via a request via line 9 to the external circuit operating the auxiliary power source). As illustrated in FIG. 6, upon system power failure (block 82), all core, L1, L2, L3, DDR PHY logic remains powered via auxiliary power until the PM DIMMs 28 have received the CPU data. For example, each core 14 can run CPU instructions that flush cache, and then wait for flush completion before placing itself into a low power or sleep mode (e.g., using existing CPU software features) as indicated by blocks 84 and 86. One core (e.g., core 14₁) can operate as a controlling core because, after it empties its STORE FIFO and L1 cache, it monitors and confirms the emptying of L2, L3, DDR PHY and the final off-SOC completion of writes to PM DDR DIMMs 28 and, as indicated generally at line 9 in FIG. 4, generates a request to terminate supply of auxiliary power to line 2 for final shutdown of the SOC 10 (blocks 88 and 90).

Other illustrative embodiments are available wherein the degree of power control varies between mostly circuitry-driven or mostly software-driven to balance the cost of complex changes to the CPUs. Further, other illustrative embodiments can perform some or more control by software and the use of existing CPU software features that puts CPU parts in low power mode.

In accordance with aspects of the illustrative embodiments, the shutdown of the stated CPU components does not interfere with the emptying of data down the illustrative hierarchy 1 through 5 or similar memory structure described above with reference to FIG. 1.

Aspects of the illustrative embodiments employ modifications to the CPU architecture related to saving power that can be complemented by CPU software methods (e.g., entering low power mode as described herein) to flush caches to special PM DIMMs in a manner that performs a specific shutdown of SOC and CPU components to these PM DIMMs at low power cost. The embodiments of the present invention are advantageous over conventional core dumps to external NVRAM because the CPU data is saved to PM DIMM for a restart.

Aspects of the illustrative embodiments are advantageous because power requirements (e.g., battery power or capacitive power) for deferred save operations are lowered Further, the need for periodic flush to persistent memory, and therefore delays associated with conventional synchronization points, is obviated. Aspects of the illustrative embodiments are particularly useful for devices requiring high speeds in memory processing such as file servers or databases.

It will be understood by one skilled in the art that this disclosure is not limited in its application to the details of construction and the arrangement of components set forth in the following description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “'connected” and “coupled” and variations thereof are not restricted to physical or mechanical connections or couplings.

In addition, it will be understood by those skilled in the art that PM DIMMs in any computer system can be replaced by PM memories soldered onto the board instead of PM DIMMs placed in slots. Accordingly, embodiments of the present invention are not limited to the use of persistent memory DIMMs (PM DIMMS).

The components of the illustrative devices, systems and methods employed in accordance with the illustrated embodiments of the present invention can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers. Functional programs, codes, and code segments for accomplishing the present invention can be easily construed as within the scope of the invention by programmers skilled in the art to which the present invention pertains.

The various illustrative logical blocks, modules, and circuits described in connection with the embodiments disclosed herein may be implemented or performed with a general purpose processor, a digital signal processor (DSP), an ASIC, as FPGA or other programmable logic device, discrete gate or transistor logic, discrete hardware components, or any combination thereof designed to perform the functions described herein

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Although the present disclosure has been described with reference to specific features and embodiments thereof, it is evident that various modifications and combinations can be made thereto without departing from scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A system on chip (SOC) having a computer processing unit (CPU) connected to persistent memory (PM) memory devices (PM memories), the SOC comprising:
a power shutdown controller comprising a power input configured to receive power from a system power source and from an auxiliary power source upon a system power failure; and
a plurality of power output lines that are connected, respectively, to designated CPU components comprising plural CPU cores, plural levels of cache and a memory physical interface to the PM memories to provide power from the power input;
wherein the power shutdown controller is configured to receive signals from at least one of the CPU components indicating when cache emptying of CPU data from the CPU components is completed after system power failure, and, in response to the indication of cache emptying completion to the PM memories, to generate an output signal to request terminating power to the power input from the auxiliary power source.

2. The SOC of claim 1, wherein the plurality of power lines comprises at least one power line that is separately controllable from the other power lines by the power shutdown controller to supply auxiliary power to and terminate auxiliary power from one or more of the CPU components that are connected to the controllable power line.

3. The SOC of claim 2, wherein the power shutdown controller comprises discrete logic components configured to terminate auxiliary power to the controllable power line based on the received signals indicating cache emptying completion of the CPU components that are connected to the separately controllable power line.

4. The SOC of claim 1, wherein two or more of the plurality of power lines are separately controllable with respect to each other and to the other power lines by the power shutdown controller to supply auxiliary power to and terminate auxiliary power from the CPU components that are connected to the controllable power lines, and the power shutdown controller is configured to terminate auxiliary power to a corresponding one of the controllable power lines based on the received signals indicating cache emptying completion of the CPU components that are connected to that controllable power line.

5. The SOC of claim 4, wherein the plurality of power output lines are connected to the CPU components selected from the group consisting of one or more CPU cores, CPU core first in first out (FIFO) memories, Level 1 (L1) cache, Level 2 (L2) cache, Level 3 (L3) cache, a coherent network, and double data rate (DDR) memory physical interfaces.

6. The SOC of claim 5, wherein the controllable power lines are connected to the CPU core FIFO memory and L1 cache of each of the CPU cores, and the power shutdown controller is configured to terminate auxiliary power to the CPU core FIFO memory and the L1 cache via corresponding ones of the controllable power lines in response to the received signals indicating cache emptying completion of the CPU core FIFO memory and L1 cache of the respective CPU cores into the L2 cache.

7. The SOC of claim 6, wherein logic units in the CPU cores are connected to the system power source and riot the power shutdown controller, the CPU core logic units being powered down upon system power failure while the CPU data continues to empty from the CPU core FIFO memory and L1 cache of each of the CPU cores.

8. The SOC of claim 5, wherein at least one of the controllable power lines is connected to the L2 cache, and the power shutdown controller is configured to terminate auxiliary power to the L2 cache via the controllable power line in response to the received signals indicating completion of emptying the data from the L2 cache to the L3 cache.

9. The SOC of claim 8, wherein at least one of the controllable power lines is connected to the L3 cache, and the power shutdown controller is configured to terminate auxiliary power via the controllable power line in response to the received signals indicating completion of emptying the data from the L3 cache to the DDR physical interface via the coherent network.

10. The SOC of claim 9, wherein the controllable power lines are connected to an interface of the coherent network and to the DDR physical interface, and the power shutdown controller is configured to terminate auxiliary power to the coherent network interface and the DDR physical interface via corresponding ones of the controllable power lines in response to the received signals indicating completion of emptying the data from the DDR physical interface to the PM memories.

11. A system on chip (SOC) having a computer processing unit (CPU) connected to persistent memory (PM) memory devices (PM memories), the SOC comprising:
a power connection circuit comprising a power input configured to receive power from a system power source and from an auxiliary power source upon a system power failure, and a plurality of power output lines that are connected, respectively, to designated CPU components comprising plural CPU cores, plural levels of cache and a memory physical interface to the PM memories to provide power from the power input, the CPU cores being configured to determine when cache emptying of CPU data to PM memories from the CPU components is completed after system power failure and having a port connected to an external circuit controlling the auxiliary power source; and
a memory storage comprising power shutdown control logic computer instructions executed by at least one of the CPU cores to generate an output signal via the port to request terminating auxiliary power to the power input in response to a determination that the cache emptying to PM memories is completed.

12. The SOC of claim 11, wherein the plurality of power output lines are connected to the CPU components selected from the group consisting of a logic unit of one or more CPU cores, CPU core first in first out (FIFO) memories, Level 1 (L1) cache, Level 2 (L2) cache, Level 3 (L3) cache, a coherent network, and double data rate (DDR) memory physical interfaces.

13. The SOC of claim 11, wherein each of the CPU cores is configured to enter a low power mode in response to an indication that cache emptying is complete at that CPU core.

14. The SOC of claim 11, wherein the at least one of the CPU cores is a controlling core that executes the power shutdown control logic computer instructions to generate the output signal in response to a determination that the other CPU cores and the controlling core have completed cache emptying of the CPU data to PM memories.

15. The SOC of claim 11, wherein the SOC comprises non-CPU components that are not involved in the cache flush of the CPU data to the PM memories, the non-CPU components are connected to the system power source and not the power connection circuit and are powered down upon system power failure while the CPU components receive power until the auxiliary power is terminated in response to the output signal.

16. The SOC of claim 11, wherein the SOC comprises non-CPU components that are not involved in the cache flush of the CPU data to the PM memories, the neon-CPU components are connected to the power connection circuit and receive power until the auxiliary power is terminated in response to the output signal.
